(19) United States
(12) Patent Application Publication
(10) Pub. No.: US 2012/0043515 A1
(43) Pub. Date: Feb. 23, 2012

(54) LIFTING DEVICE FOR LIFTING LOADS, PARTICULARLY VEHICLES

(76) Inventors: Gerhard Finkbeiner, Freudenstadt (DE); Josef Femböck, Neuotting (DE)

(21) Appl. No.: 13/264,785

(22) PCT Filed: Apr. 19, 2010
(86) PCT No.: PCT/EP2010/002370

§ 371 Date: Oct. 17, 2011

(30) Foreign Application Priority Data
Apr. 17, 2009 (DE) 20 2009 005 662.7

(51) Int. Cl. B66F 3/24; B66F 7/28; B66F 7/08

(52) U.S. Cl. 254/93 R; 254/124

(57) ABSTRACT

The invention relates to a lifting device for lifting loads, in particular vehicles, comprising load receiving means which can be raised and lowered by means of at least one lifting element, and a drive device which is controlled by a drive control. Said lifting device is characterised in that an energy accumulator, which supplies the drive control and the drive device with energy, is provided on the lifting element, the load receiving means or inside a working area of the load receiving means or the lifting element.

The invention relates to a lifting device for lifting loads, particularly vehicles or similar.

A lifting device for lifting loads, particularly vehicles or similar, which is designed as a rail lifting platform, is known in DE 20 2006 014 183 U1. Two parallel running rails are moved up and down by a lifting element. These lifting elements are designed as scissors, which comprise two crossing scissor levers. A cylinder is provided for moving the rail up and down, which on one hand engages on the rail, and on the other hand, engages on a crossing point between the two scissor levers. Drive equipment, which includes an electric hydraulic pump and a valve control unit of the hydraulic cylinder, is arranged in the rail.

For power supply of a lifting device of this type, it is required that this is connected to the local supply network by a power connection. If there is a power failure of the supply network, it is not possible to operate the lifting platform. In addition, this lifting device has the disadvantage that the drive control must be adapted to different power supply networks in the respective countries, so that it is possible to operate the lifting device. In addition, a locally limited field of application is given by this power supply.

The object of the invention is therefore to create a lifting device for lifting loads, particularly vehicles, which facilitates an energy supply which is independent of location, in order to operate the lifting device.

The object is achieved by the lifting device comprising an energy storage device, which is provided on a lifting element or on a load pick up of the lifting device, or within a working area of the load pick up or the lifting device, and powers the drive control as well as the drive equipment of the lifting device. Due to the integration of an energy storage device on the lifting device or within the working area of the load pick up or the lifting element, such as on the floor or near to the floor, on which the lifting elements are supported, this is self-sufficient in operation and independent of the locally available power networks, particularly of their frequencies or voltages. In fact, a standard drive control and standard drive equipment can be created, which are powered by the energy storage device. The production of lifting devices of this type is therefore cost-effective. At the same time, the design of the components is standard for all lifting devices. Due to the configuration of the lifting device with an energy storage device, is also possible that a direct power connection via a cable to the local power network is not required. Therefore, the installation location of the lifting device is independent of local conditions or local power supply connections.

According to a preferred configuration of the invention, it is intended that the drive equipment comprises at least one hydraulic unit and a hydraulic control for driving a hydraulic cylinder, and preferably an electric motor, and that the drive equipment is arranged on the load pick up or on the lifting element. Through this, a completely closed hydraulic system can be provided for a lifting device, and this hydraulic system can be closed even before delivery and tested.

According to a further advantageous configuration of the invention, it is intended that the drive control is arranged on the load pick up or lifting element, or within a working area of the load pick up or lifting element. Short current paths can therefore be achieved. Simultaneously, there is also a saving of expensive power cables. It is preferably intended that the drive control, drive equipment and energy storage device are always assigned to one another and form a compact unit. For example, all components can be provided within the rail or underneath the rail. These can also be attached on the lifting element. The associated movement of these components is negligible in relation to the loads to be lifted.

According to a further advantageous configuration of the invention, it is intended that the drive control is designed wirelessly. Therefore, for example, two or several load handling attachments, which engage on a load or a vehicle, are driven simultaneously, without connection cables being required between or to the respective lifting devices of the load handling attachments. Furthermore, in turn, an installation and control of the lifting device can be facilitated independently of location.

According to a further advantageous configuration of the invention, it is intended that the energy storage device can be attached to a quick change device, which is arranged on the load handling attachment or the lifting element. A constant operational readiness is therefore given. This operational readiness is also present, then, if there is a power failure over a longer period. In addition, due to the quick change device, an easier and quicker exchange of the discharged energy storage device with a fully charged energy storage device can take place.

The lifting element of the lifting device can be designed as half-scissors, according to a first embodiment. Half-scissors of this type can move a load handling attachment up and down. Equally, two or several half-scissors can engage together on a load handling attachment. The same applies for the use of scissors, which includes two crossing scissor levers. Furthermore, the lifting element can alternatively be designed as a lift piston. Furthermore, two or several scissor levers spaced apart from each other can be arranged between a floor mounting and a load handling attachment, which effectuate a guided up and down movement of the load handling attachment by interacting with the hydraulic cylinder. Any combination of the above-named embodiments can also be provided.

The load handling attachment of the lifting device can be designed as mobile columns. Alternatively, the load handling attachment can be designed as moveable support arms or as rails.

Furthermore, a charging cable can preferably be attached to the drive control or to the at least one energy storage device of the lifting device. In this embodiment, the drive control or the energy storage device or both preferably comprise a charging circuit for monitoring the state of charge of the energy storage device. This makes it possible for the energy storage device or the replacement energy storage device to be charged without removal, whereby for driving the lifting device, virtually only a luminous flux is required, in order to charge the energy storage device. In Germany, for example, there is a 1-pole mains voltage of 230V. Operation of the lifting device is powered by the energy storage device. In addition, this arrangement has the advantage that only the charging circuit, if this is required, is to be adapted to the local characteristics of the mains supply voltage.

According to a preferred configuration of the invention, it is intended that the drive control and/or the energy storage device and/or the quick change device and/or at least one component of the drive equipment can be arranged on a holding device, particularly a mounting panel, which is attached to the load pick up, the lifting element or on the floor in the working area of the load pick up or the lifting element. Through this, a simple assembly of all components for control of the lifting device is facilitated. Additionally, it is possible to provide an attachment of the holding device to the load pick up, lifting element or the floor in the working region of the load pick up, which can be easily adapted to different installation situations. Furthermore, the holding device can form a type of adapter, in order to attach different components for the drive control and the drive equipment according to the application.

A further advantageous configuration of the invention intends that the half-scissors or scissors are formed from two scissor levers arranged in parallel and spaced apart from each other, as well as brackets or further scissor levers pivotally mounted in the crossing point, and that between the scissor levers, at least the energy storage device or the holding device at least for receiving the energy storage device is arranged. A space-saving arrangement of the at least one energy storage device is therefore made possible between the scissor levers. In particular, the holding device is integrated between the scissor levers, whereby preferably all components for the activation of the lifting device are provided on the holding device between the scissor levers.

A further preferred configuration of the lifting device intends that a plug-in connection for a charging cable or power supply cable is provided on the drive control, and the drive control preferably includes a charging circuit for monitoring the state of charge of the energy storage device. This allows the energy storage device or replacement energy storage device, for example, and simultaneously the energy storage device(s) arranged in the lifting column, to be charged in a charging station, particularly if the lifting device is not in use.

According to a further preferred configuration of the invention, the energy storage device includes an energy storage control, which is provided on or in a housing which accommodates the energy storage device, and records the state of charge of the energy storage device. The integrated intelligence of the energy storage device and the energy management can be improved through this integration. This control preferably includes a microcontroller, which monitors the state of charge of the energy storage device. Preferably, the corresponding charging characteristic for the respective accumulator used is stored in the microcontroller, so that an improved utilisation is facilitated for the charge and discharge of the respective accumulator, and can be controlled by this energy storage control. Through this, simultaneously, the residual charge of the energy storage can be safely determined, in order to prevent a premature failure or standstill of the lifting device, and to signal in good time the exchange of the energy storage device due to a fault or a residual charge, which is too low. For this, a visual, acoustic or tactile display can preferably be provided, which at least signals that an exchange of the energy storage device is required due to a residual charge, which is too low. During the control of the lifting device, the current and the duration of the current can be simultaneously recorded in the charging and discharging direction by an energy storage control of this type. Through this, the current capacity can be analysed on the state of charge of the energy storage device.

According to a preferred configuration of the invention, the energy storage device includes a charging circuit, which is provided in a housing, which accommodates the energy storage device. Thus, the energy storage device can be charged both on the lifting columns as well as also directly on a separate power supply connection point, without an extra charging station being necessary. The charging circuit can be configured for use for different supply voltages or frequencies of the supply networks, and hence transform the direct current necessary for the control of the lifting device.

Furthermore, the energy storage device preferably comprises at least one data interface, particularly a wireless data interface, which communicates with the control. A direct transmission of data between the control and the microcontroller of the energy storage device can thus take place. Alternatively, a wired transmission of data can also be provided, whereby a plug contact is preferably installed in the housing, which accommodates the energy storage device, which plug contact engages on a complementary plug contact of the quick change device.

A further preferred configuration of the invention intends that the quick change device, particularly the receiving space of the quick change device, is attached to a printed circuit board, which comprises conducting paths, which lead to the drive control and/or to the electric motor of the drive equipment or to the hydraulic control. Printed circuit boards of this type have the advantage that one can dispense with traditional wiring by means of individual cables. In fact, a printed or etched circuit board is provided, which includes the corresponding conducting paths, in order to connect the individual components together. Through this, assembly is made considerably easier. Simultaneously, a modular design can be considerably improved, since defined connection contacts or contact elements are provided along the printed circuit board for the components to be connected. The energy is then transferred via this printed circuit board instead of via connecting cables. In the process, a modified embodiment of this printed circuit board can be provided in such a way that on attachment of the printed circuit board to the lifting column, the lifting column is itself designed as a conductor, as is known in the body work of automobiles, for example.

The invention as well as advantageous embodiments and further developments of the same are subsequently explained in more detail and described by means of the examples shown in the drawings. The features to be taken from the description and the drawings can be used individually or in any combination according to the invention. In the drawings:

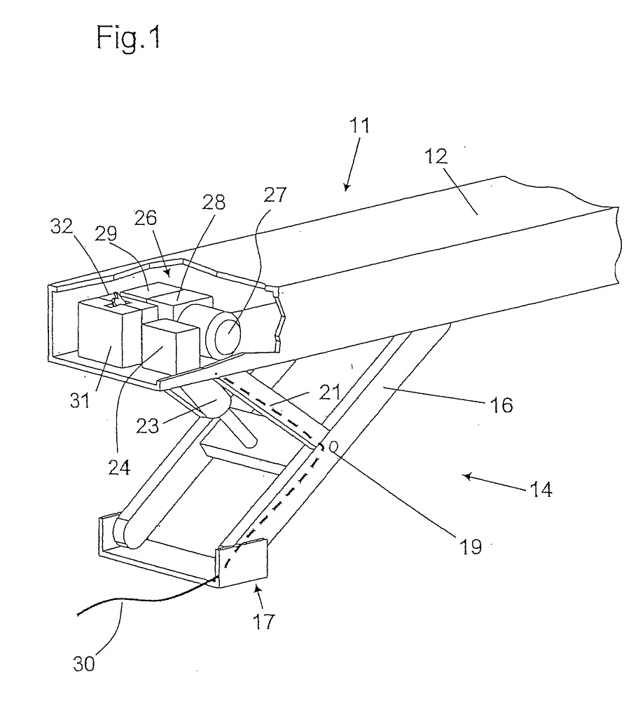

FIG. 1 shows a perspective view of a lifting device,

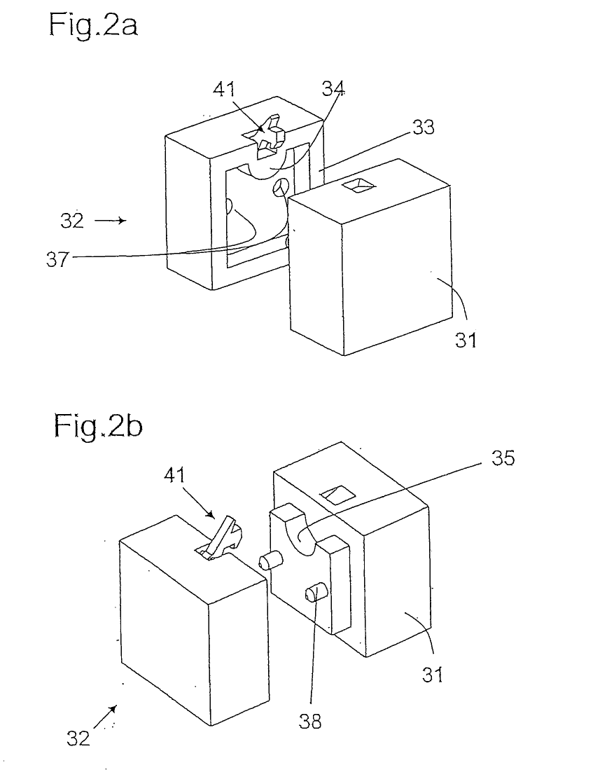

FIGS. 2a and b show perspective representations of a quick replacement device with an energy storage device,

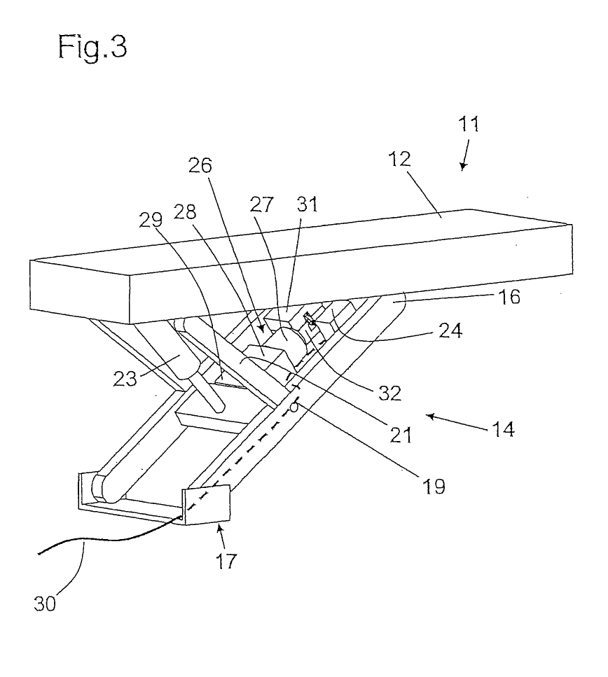

FIG. 3 shows a perspective view of an alternative embodiment of the lifting device according to FIG. 1 and

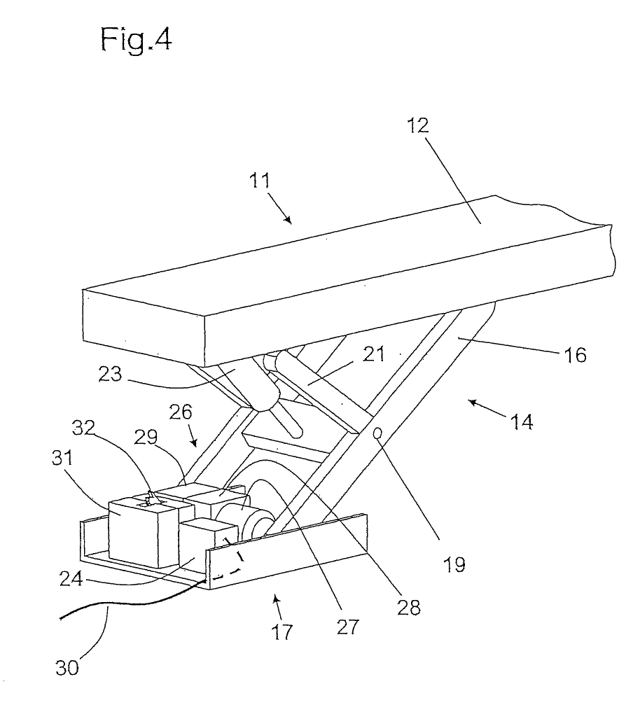

FIG. 4 shows a perspective view of an alternative embodiment of the lifting device according to FIG. 1.

A schematic view of a lifting device 11 is shown in FIG. 1, which is designed as a so-called rail lifting platform. For lifting a vehicle, two lifting devices 11 are arranged in parallel to one another. The lifting device 11 includes a load handling attachment 12, which is designed as a rail. For moving the load pick up 12, a lifting element 14 is provided, which is designed as half-scissors according to the execution example. A scissor lever 16 is pivotally mounted with its end on a subsurface or a floor mounting 17. Oppositely, the scissor lever 16 engages with the load pick up 12. Between a crossing point 19 and the load pick up 12, a bracket 21 is provided, which is arranged on the load pick up 12 in such a way that it is easy to move. These half-scissors can also be arranged turned 180°, so that only one end of the scissor lever engages on the load pick up 12 and the opposite end of the bracket 21 lies on the floor or is fixed to the floor.

A hydraulic cylinder 23, which works between the crossing point 19 and the load pick up 12, is controlled by a drive control 24 and drive equipment 26 for the up and down movement of the load handling attachment 12. The drive equipment 26 includes an electric motor 27 as well as a hydraulic unit 28 and a hydraulic control 29, which is not shown in detail.

For energy supply of the drive control 24 and drive equipment 26, an energy storage device 31 is provided, which is preferably accommodated by a quick change device 32, which is described in more detail in FIG. 2. This energy storage device 21 is preferably designed as a high performance accumulator and consists, for example, of lithium-ion batteries. Due to the energy storage device 31, the drive control and drive equipment can be provided with direct current.

The drive control 24, the drive equipment 26 as well as the energy storage device 31 are preferably arranged together in a spatially compact way, and provided in the load handling attachment 12, for example. Alternatively, these components can also be arranged underneath in or on the load handling attachment 12.

The energy storage device 31 can be charged on a charging station arranged separately from the lifting device 11. Therefore, individual energy storage devices can be charged during the operation of the lifting device 11. A completely charged energy storage device 31 is thus always available for exchange.

The drive control 24 or the energy storage device 31 can also comprise a connection, to which a power cable or charging cable 30 can be attached. This charging cable 30 is preferably led along the lifting element 14 to the floor and to a feed-source. Through this charging cable 30, a charging current can be provided, so that the energy storage device 31 is charged by a charging circuit.

The quick change device 32 is shown in perspective in FIGS. 2a and b. This quick change device 32 includes a mounting frame 33, which is designed as a plug-in base according to the execution example. A projection or protrusion 34, which corresponds to a complementary recess 35 on the energy storage device 31, is provided on the mounting frame 33. It is therefore ensured that the energy storage device 31 can only be used in a defined plug position in the mounting frame 33, and electrical contacting of the energy storage device 29 to the quick change device 32 takes place. Spring-loaded contact pins 38 are preferably arranged as electrical contacts on the energy storage device 31, which engage on the contact elements 37 in the mounting frame 33, when the energy storage device 31 and the quick change device 32 are in a locked state. The quick change device 32 is connected to the drive control 24 by the contact elements 37. A locking element 41 such as a snap-in hook or a latching hook is provided for simple replacement of the energy storage device 31. Through simple attachment of the energy storage device 31 to the quick change device 32, contacting takes place, as well as preferably an independent locking of the locking elements 41 to the energy storage device 29.

In contrast to FIG. 1, a lifting device 11 is shown in FIG. 3, in which the arrangement of the drive control 24, drive equipment 26, energy storage device 31 and quick change device 32 is intended on the lifting element 14. In this process, it is preferably intended that the individual components are integrated between both scissor levers 16, which are arranged adjacently to one another. In particular, the individual components are attached to a holding device, which can be attached between both scissor levers 16. Through this, an arrangement can be created, in which the components remain in a lowered form between both scissor levers 16, and the scissor levers 16 themselves can also at least partly dip into the load pick up 12. The holding device is preferably designed as a supporting structure or mounting panel, so that the individual components can be attached thereto in a simple manner and assigned to one another. Simultaneously, this holding device can also comprise or accommodate a printed circuit board, so that a simultaneous electrical contacting is given directly after the assembly of the individual components. Through this, the assembly work is made easier. A modular design is made possible by the arrangement of all components on the holding device.

The drive control 24 and the components of the drive equipment 26 are preferably provided between a crossing point 19 of the scissor lever 16 and a bearing axis, through which the scissor lever 16 is swivel-mounted on the load pick up 12. This arrangement allows the lifting cylinder and the bracket 21 to be arranged in a rest position or lowered position within the scissor levers 16, and in the second half, the drive control 24 as well as the drive equipment 26 with their components. Depending on the constructive configuration of the lifting element 14 or the arrangement of the hydraulic cylinder 23, alternative positions of the holding device can be provided between the scissor levers or brackets. Furthermore, alternatively, it can be provided that individual components are arranged between the scissor brackets 16 and/or bracket 21 and a part of the components in the load pick up 12 or on the load pick up 12.

An embodiment of the lifting device 11, which is alternative to the embodiments according to FIGS. 1 and 3, is shown in FIG. 4. In this embodiment it is intended that the control device 24 and the control device 26 are arranged within a working area of the load pick up 12 or the lifting element 14, particularly on the floor. For example, the drive control 24 and drive equipment 26 are provided for floor mounting 17 in such a way that in the case of a lowered load pick up 12, the individual components are covered and protected by the load pick up 12. This positioning is only as an example and can take different positions along the load pick up 12. Preferably, the individual components of the drive control 24 and drive equipment 26 can again be provided on a holding device.

1. A lifting device for vehicles, with a load handling attachment, which is moved up and down with at least one lifting element, with drive equipment, which is controlled by a drive control, wherein an energy storage device, which provides the drive control and the drive equipment with energy, is provided on the lifting element, load pick up or within a working area of the load pick up or the lifting element.

2. A lifting device according to claim 1, wherein the drive equipment comprises at least one hydraulic unit and a hydraulic control for driving a hydraulic cylinder.

3. A lifting device according to claim 1, wherein the drive control is arranged on the load pick up, lifting element or within a working area of the load pick up or on the lifting element.

4. A lifting device according to claim 3, wherein a wireless drive control is provided.

5. A lifting device according to claim 1, wherein the energy storage device is attached to a quick change device, which is arranged on the load pick up or lifting element.

6. A lifting device according to claim 1, wherein the lifting element is designed as half-scissors, scissors, a lift plunger, or formed by at least two scissor levers spaced apart from each other.

7. A lifting device according to claim 1, wherein the load pick up is designed as a mobile column element, a supporting arm or a rail.

8. A lifting device according to claim 1, wherein a charging cable is attached to the drive control or the energy storage device.

9. A lifting device according to claim 1, wherein at least the drive control or the energy storage device or the quick change device or a component of the drive equipment is attached to a mounting panel of a holding device, which is attached on the load pick up, lifting element or in the working area of the load pick up or the lifting element.

10. A lifting device according to claim 9, wherein the half-scissors or scissors include two scissor levers arranged in parallel and spaced apart from one another, as well as a bracket swivel-mounted in the crossing point, or other scissor levers, and that between the scissor levers at least the energy storage device or the holding device is arranged for accommodating the energy storage device.

11. A lifting according to claim 1, wherein the energy storage device includes an energy storage control, which is provided on or in a housing which accommodates the energy storage device, and which monitors the state of charge of the energy storage device.

12. A lifting device according to claim 1, wherein the energy storage device includes a charging circuit, which is provided on or in a housing which accommodates the energy storage device.

13. A lifting device according to claim 1, wherein the energy storage device comprises at least one data interface which communicates with the drive control.

14. A lifting device according to claim 1, wherein a mounting frame of the quick change device, is attached to a printed circuit board, which comprises conducting paths, which lead from contact elements of the quick change device to the drive control or to the electric motor or to both of the drive equipment or to the hydraulic control or to both.

15. A lifting device according to claim 14, wherein the printed circuit board comprises current sensors, through which, the state of charge of the energy storage device is ascertained.

16. A lifting device according to claim 1, wherein the drive equipment comprises an electric motor, which are arranged on the load pick up or on the lifting element, which is arranged on the load pick up or on the lifting element.

17. A lifting device according to claim 9, wherein the half-scissors or scissors include two scissor levers arranged in parallel and spaced apart from one another, as well as a bracket swivel-mounted in the crossing point, or other scissor levers, and that between the scissor levers at least the energy storage device or the holding device is arranged for accommodating the energy storage device.
